(19) United States
(12) Patent Application Publication
(10) Pub. No.: US 2022/0328238 A1
(43) Pub. Date: Oct. 13, 2022

(54) TRANSFORMER CONNECTION METHOD AND POWER SUPPLY UNIT

(71) Applicant: SHARP KABUSHIKI KAISHA, Osaka (JP)

(72) Inventors: TAKESHI SHIOMI, Osaka (JP); SHINOBU YAMAZAKI, Osaka (JP); KENTARO KISHIRA, Osaka (JP)

(21) Appl. No.: 17/705,831

(22) Filed: Mar. 28, 2022

(30) Foreign Application Priority Data
Apr. 8, 2021 (JP) 2021-065935

(51) Int. Cl. H01F 27/29; H02M 3/24; H01F 27/28

(52) U.S. Cl. CPC H01F 27/29; H02M 3/24; H01F 27/2876

(57) ABSTRACT

A transformer connection method for a transformer includes a first high-frequency terminal configured as a first end of a first plate winding, a second high-frequency terminal configured as a first end of a second plate winding, and a direct current terminal connected to a second end of the first plate winding and a second end of the second plate winding. The transformer connection method comprises connecting the first high-frequency terminal and the second high-frequency terminal to a circuit board to cause the first high-frequency terminal and the second high-frequency terminal to be upright from a surface of the circuit board; and connecting the direct current terminal to a component or to the circuit board connecting with the component, the direct current terminal extending from a portion between the transformer and the circuit board to an outside.

### BACKGROUND

### 1. Field

The present disclosure relates to a transformer connection method.

### 2. Description of the Related Art

A transformer is used in a power supply unit (or a power supply circuit). Current flowing through the transformer causes conduction loss in wires in the transformer. Japanese Unexamined Patent Application Publication No. 2014-93926 discloses a transformer connection method that addresses conduction loss reduction.

### SUMMARY

However, even though such a transformer connection method is used, there is still room to reduce the conduction loss. In an aspect of the present disclosure, it is desirable to provide a transformer connection method enabled to reduce conduction loss more than in the related art.

According to an aspect of the disclosure, there is provided a transformer connection method for a transformer including a first high-frequency terminal configured as a first end of a first plate winding, a second high-frequency terminal configured as a first end of a second plate winding, and a direct current terminal connected to a second end of the first plate winding and a second end of the second plate winding. The transformer connection method includes: connecting the first high-frequency terminal and the second high-frequency terminal to a circuit board to cause the first high-frequency terminal and the second high-frequency terminal to be upright from a surface of the circuit board; and connecting the direct current terminal to a component or to the circuit board connecting with the component, the direct current terminal extending from a portion between the transformer and the circuit board to an outside.

### BRIEF DESCRIPTION OF THE DRAWINGS

FIG. 1 is a diagram explaining a transformer connection method according to Embodiment 1;

FIG. 2 is a cross-sectional diagram taken along a line A1 in FIG. 1; and

FIG. 3 is a diagram illustrating the configuration of a power supply unit including a DC/DC converter to which the transformer connection method in FIG. 1 is applied.

### DESCRIPTION OF THE EMBODIMENTS

### Embodiment 1

Conduction loss causes heat generation in a winding in a transformer. To achieve high power density of the transformer, the transformer is to be subject to downsizing using a high frequency and high power using high current. To reduce conduction loss in direct current in the transformer, making the transformer wires thicker is effective.

However, conduction loss in high-frequency current is greatly influenced by skin effect. Accordingly, simply making the transformer wires thicker is not sufficient as a countermeasure against the conduction loss in the high-frequency current.

In an aspect of the present disclosure, a method for reducing conduction loss in a high-frequency transformer using frequencies from about 20 kHz to about 1 MHz in which high current from about 10 to about 1000 A flows is described by using the high-frequency transformer (hereinafter, simply referred to as a transformer).

Since a current of about 160 A flows through the transformer at a frequency of about 66 kHz in Embodiment 1, transformer windings experience high heat generation due to conduction loss. To reduce the conduction loss, improvement has been made by a transformer connection method according to the aspect of the present disclosure.

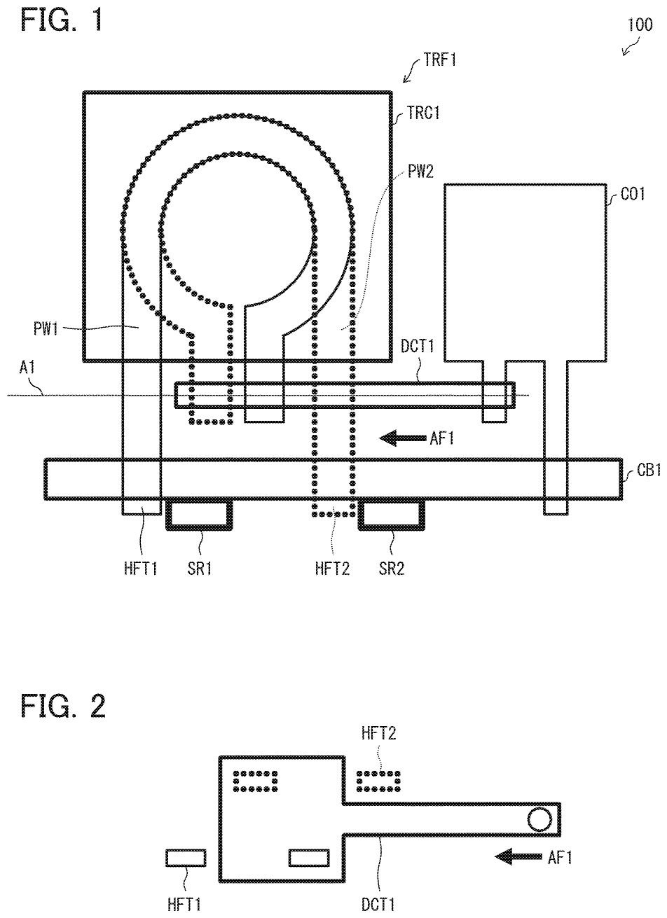

FIG. 1 is a diagram explaining a method for connecting a transformer TRF1 according to Embodiment 1. Specifically, FIG. 1 is a perspective side view of the transformer TRF1. FIG. 2 is a cross-sectional diagram taken along a line A1 in FIG. 1.

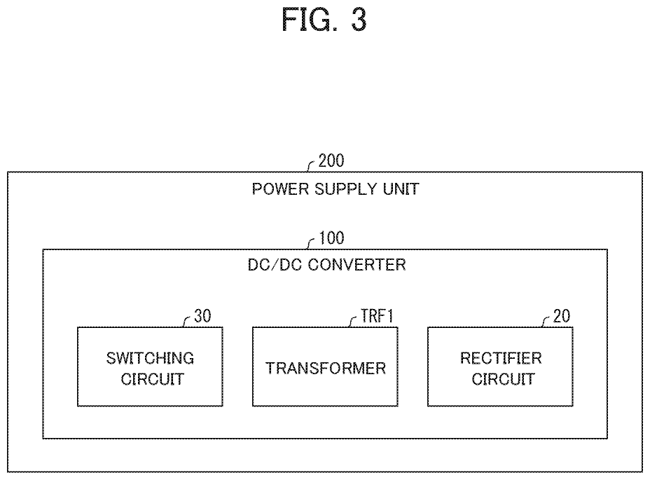

FIG. 3 is a diagram illustrating the configuration of a power supply unit 200 including a DC/DC converter 100 to which the transformer connection method according to the aspect of the present disclosure is applied. As illustrated in FIG. 3, the DC/DC converter 100 includes a rectifier circuit 20 and a switching circuit 30 in addition to the transformer TRF1.

For simplified description herein, for example, a first plate winding PW1 is also referred to as a PW1 simply. In addition, note that numeric values herein are merely examples.

### Transformer TRF1 Overview

The transformer TRF1 in Embodiment 1 is a component of the DC/DC converter 100. The TRF1 includes a transformer core TRC1. The TRF1 includes a primary winding (not illustrated) and a secondary winding inside the TRC1. The TRF1 is connected to the switching circuit 30 on the primary side in the DC/DC converter 100 with the primary winding interposed therebetween.

The secondary winding in the TRF1 has a center-rapped winding structure. The secondary winding in the TRF1 is connected to the rectifier circuit 20 on the secondary side in the DC/DC converter 100 with a first high-frequency terminal HFT1, a second high-frequency terminal HFT2, and a direct current terminal DCT1 interposed therebetween, the HFT1, the HFT2, and the DCT1 serving as the terminals of the secondary winding.

Typically, a primary side winding (primary winding) and a secondary side winding (secondary winding) that are the windings of a transformer are sometimes referred to as a primary side coil and a secondary side coil, respectively, but naming as the primary side winding and the secondary side winding is used in Embodiment 1 to avoid coexistence with a coil CO1 described later.

### Switching Circuit 30

The switching circuit 30 is used to apply an alternating voltage to the TRF1. A full bridge circuit is applied to the switching circuit 30 in Embodiment 1. However, any switching circuit such as an LLC, a dual active bridge (DAB), or a push pull circuit may be applied to the switching circuit 30.

### Rectifier Circuit 20

The rectifier circuit 20 is used to rectify an AC electromotive force of the TRF1. A center-tapped synchronous rectifier circuit is applied to the rectifier circuit 20 in Embodiment 1. However, any circuitry system operable with a center-tapped winding may also be applied to the rectifier circuit 20.

### Secondary Winding Structure and Connection Method

The center-tapped winding in the TRF1 includes three copper plates that are the first plate winding PW1, a second plate winding PW2, and the direct current terminal DCT1. Since these members have a three-dimensional structure, FIGS. 1 and 2 disclose the structure to verify the structure of each member.

In FIG. 1 as a perspective view, the solid line for the PW1 and the dotted line for the PW2 overlap each other partially in the circular portion. This denotes that the edges of the PW1 on the front side and the edges of the PW2 on the rear side are located on the same position.

The PW1 and the PW2 are each a coil with one turn and formed as a copper plate about 1 mm thick and about 5 mm wide. Respective surfaces of the PW1 and the PW2 are disposed in such a manner as to be upright from (for example, perpendicular to) a surface of a circuit board CB1 of the DC/DC converter 100. The terminals for the high-frequency current flow at about 66 kHz are configured by extending respective first end of the PW1 and the PW2.

The first high-frequency terminal HFT1 is configured as the first end of the PW1. The second high-frequency terminal HFT2 is configured as the first end of the PW2. The HFT1 and the HFT2 are connected to the CB1 through a through hole in such a manner as to be upright from (for example, perpendicular to) the surface of the CB1.

In addition, the HFT1 is connected to a first rectifier element SR1 of the DC/DC converter 100 with a pattern of the CB1 interposed therebetween. Likewise, the HFT2 is connected to a second rectifier element SR2 of the DC/DC converter 100 with a pattern of the CB1 interposed therebetween.

A second end of each of the PW1 and the PW2 is connected to the DCT1 through a through hole. The DCT1 takes a role as a direct current terminal for direct current flow.

The DCT1 in Embodiment 1 is a plate terminal (plate wire). Specifically, the DCT1 is formed as a copper plate about 1.2 mm thick. Part of the DCT1 may be disposed between the TRF1 and the CB1, with a surface of the DCT1 facing the CB1. An end of the DCT1 is extended and connected to the coil CO1 of the DC/DC converter 100.

### Effects of Secondary Winding Structure and Connection Method

The high-frequency current causes the skin effect on the wires of the transformer. Accordingly, simply making the wires thicker is not sufficient to reduce the conduction loss in the high-frequency current. Hence, Embodiment 1 employs the connection method in which the first end of each of the PW1 and the PW2 is directly mounted on the circuit board. As described above, the total wire length of the transformer is shortened without interposition of other members, and thereby the conduction loss may be reduced.

The second end of each of the PW1 and the PW2 is connected to the DCT1. Since the direct current flows to the DCT1, controlling the cross section of each wire may lead to control of the conduction loss. Accordingly, using the DCT1 having a thickness and a width that are different from those of the PW1 or the PW2 may lead to the conduction loss reduction.

As understood from the description above, the DCT1 extends from the portion between the TRF1 and the CB1 to the outside. The DCT1 may thereby be connected to a component (for example, the CO1) or to the circuit board connecting with the component, in accordance with the purpose. In this case, the thickness and the width of the DCT1 may be controlled freely, thus leading to more flexible connection.

### Plate Winding Heat Radiation Using Direct Current Terminal

The high-frequency current causes high heat generation in the TRF1 in the PW1 and the PW2. In the TRF1, the DCT1 thus takes a role to diffuse heat caused by the PW1 and the PW2. A relationship between the thickness of the DCT1 and the area of contact of the DCT1 with the PW1 and the PW2 influences thermal contact resistance between the DCT1 and the PW1 and the PW2.

If the DCT1 is less than about 0.5 times the thickness of the PW1 and the PW2, the heat in the PW1 and the PW2 is not transferred to the DCT1 easily. Accordingly, the DCT1 may be not less than about 0.5 times the thickness of the PW1 and the PW2.

For effective heat radiation to the air with the DCT1, a distance between the CB1 and the DCT1 may be long because only taking a countermeasure limited to the thickness of the DCT1 has a possibility of deteriorating the efficiency of heat radiation to the air with the DCT1.

Specifically, the distance between the CB1 and the DCT1 may be from about two times to about 40 times the thickness of the DCT1. This is because if the distance is excessively long, the HFT1 and the HFT2 become long, thus having a possibility of a conduction loss increase.

### Forced Cooling of High-Frequency Terminal and Direct Current Terminal

Forced cooling is effective to radiate heat from the PW1 and the PW2 more efficiently. The air flow direction of the forced cooling may be the direction represented by an arrow AF1 illustrated in FIGS. 1 and 2. Specifically, air may flow between the TRF1 and the CB1 and over the respective surfaces of the HFT1 and the HFT2 (for example, parallel to the respective surfaces of the HFT1 and the HFT2), and the air flow direction may be reverse to the AF1. This is because causing air to flow over the respective surfaces of the HFT1 and the HFT2 leads to smooth air flow, thus improving the cooling effect.

### Connecting High-Frequency Terminal and Direct Current Terminal to Center-tapped Synchronous Rectifier Circuit

The HFT1 and the HFT2 allow the flow of a current of about 160 A at about 66 kHz. Since a lot of current flows through the HFT1 and the HFT2, a center-tapped synchronous rectifier circuit using a metal-oxide-semiconductor field effect transistor (MOSFET) may be applied to the rectifier circuit 20. The MOSFET is thus used as the SR1 and the SR2 in Embodiment 1.

The center-tapped synchronous rectifier circuit has the following configuration. The drain terminal of the SR1 is connected to the HFT1, and the source terminal of the SR1 is connected to GND (the ground terminal) of the secondary side circuit. The drain terminal of the SR2 is connected to the HFT2, and the source terminal of the SR2 is connected to GND of the secondary side circuit.

An end of the CO1 is directly connected to the DCT1 through a through hole. This is because the direct connection achieves lower resistance than in connection with interposition of the circuit board. Another DCT1 connection method is a method by which the DCT1 is connected to the CO1 with the CB1 interposed therebetween. Alternatively, the DCT1 may be connected to the CO1 with any board (for example, a circuit board) other than the CB1 interposed therebetween. In this case, a distance including the board is to be held down to a short distance. The CO1 is an example of a component according to the aspect of the present disclosure. The component may be a capacitor or a resistor. A second end of the CO1 is connected to the positive electrode of an output capacitor (not illustrated) of the DC/DC converter 100. The negative electrode of the output capacitor is connected to GND of the secondary side circuit.

Connecting the components on the secondary side in the TRF1 to the center-tapped synchronous rectifier circuit as described above may also reduce loss in the DC/DC converter 100. Further, loss in the power supply unit 200 including the DC/DC converter 100 may also be reduced.

### Summarization

A transformer connection method according to a first aspect of the present disclosure is a transformer connection method for a transformer including a first high-frequency terminal configured as a first end of a first plate winding, a second high-frequency terminal configured as a first end of a second plate winding, and a direct current terminal connected to a second end of the first plate winding and a second end of the second plate winding. The transformer connection method includes: connecting the first high-frequency terminal and the second high-frequency terminal to a circuit board to cause the first high-frequency terminal and the second high-frequency terminal to be upright from a surface of the circuit board; and connecting the direct current terminal to a component or to the circuit board connecting with the component, the direct current terminal extending from a portion between the transformer and the circuit board to an outside.

According to the configuration above, a distance for connecting a high-frequency terminal configured as a first end of a plate winding to a circuit board may be shortened. Conduction loss due to the high-frequency current may thus be reduced. In addition, since the thickness of a wire extending up to the component may be changed to any thickness by using the direct current terminal before the connection, low resistance may be achieved.

In the transformer connection method according to a second aspect of the present disclosure, the direct current terminal may be a plate terminal. The direct current terminal may be not less than about 0.5 times a thickness of the first plate winding. A surface of the direct current terminal and a surface of the circuit board may be disposed to face each other. A distance between the direct current terminal and the circuit board may be from about two times to about 40 times a thickness of the direct current terminal.

According to the configuration above, setting the direct current terminal to be not less than about 0.5 times the thickness of the plate winding enables a large area of contact between the plate winding and the direct current terminal and enables efficient heat transfer to the direct current terminal. In addition, the plate winding heat absorbed by the direct current terminal may be efficiently radiated in the distance that is not less than about two times the thickness of the direct current terminal. Further, since the distance of not more than about 40 times the thickness of the direct current terminal restrains the high-frequency terminal from becoming long, the conduction loss in the high-frequency terminal may be reduced.

In the transformer connection method according to a third aspect of the present disclosure, air for cooling the first high-frequency terminal and the direct current terminal may flow between the transformer and the circuit board and over a surface of the first high-frequency terminal.

According to the configuration above, the high-frequency terminal and the direct current terminal may be cooled efficiently.

A power supply unit according to a fourth aspect of the present disclosure includes a DC/DC converter including the transformer. The DC/DC converter includes a first rectifier element, a second rectifier element, and a coil. By using the transformer connection method according to the first aspect, the first rectifier element is connected to the first high-frequency terminal, the second rectifier element is connected to the second high-frequency terminal, and the coil is connected to the direct current terminal.

According to the configuration above, the temperature of a transformer in the DC/DC converter in the power supply unit may be restrained from increasing.

### Addition

Each aspect of the present disclosure is not limited to the embodiment described above. Various modification may be made in the scope of claims, and an embodiment obtained by appropriately combining technical means disclosed in different embodiments is also included in the technical scope of the aspect of the present disclosure. Further, a new technical feature may be created by combining the technical means disclosed in the embodiments.

While there have been described what are at present considered to be certain embodiments of the disclosure, it will be understood that various modifications may be made thereto, and it is intended that the appended claims cover all such modifications as fall within the true spirit and scope of the disclosure.

The present disclosure contains subject matter related to that disclosed in Japanese Priority Patent Application JP 2021-065935 filed in the Japan Patent Office on Apr. 8, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A transformer connection method for a transformer including
a first high-frequency terminal configured as a first end of a first plate winding,
a second high-frequency terminal configured as a first end of a second plate winding, and
a direct current terminal connected to a second end of the first plate winding and a second end of the second plate winding, the transformer connection method comprising:
connecting the first high-frequency terminal and the second high-frequency terminal to a circuit board to cause the first, high-frequency terminal and the second high-frequency terminal to be upright from a surface of the circuit board; and
connecting the direct current terminal to a component or to the circuit board connecting with the component, the direct current terminal extending from a portion between the transformer and the circuit board to an outside.

2. The transformer connection method according to claim 1,
wherein the direct current terminal is a plate terminal,
wherein the direct current terminal is not less than about 0.5 times a thickness of the first plate winding,
wherein a surface of the direct current terminal and a surface of the circuit board are disposed to face each other, and
wherein a distance between the direct current terminal and the circuit board is from about two times to about 40 times a thickness of the direct current terminal.

3. The transformer connection method according to claim 1,
wherein air for cooling the first high-frequency terminal and the direct current terminal flows between the transformer and the circuit board and over a surface of the first high-frequency terminal.

4. The transformer connection method according to claim 2,
wherein air for cooling the first high-frequency terminal and the direct current terminal flows between the transformer and the circuit board and over a surface of the first high-frequency terminal.

5. A power supply unit comprising a DC/DC converter including the transformer according to claim 1,
wherein the DC/DC converter includes a first rectifier element, a second rectifier element, and a coil,
wherein by using the transformer connection method according to claim 1,
the first rectifier element is connected to the first high-frequency terminal,
the second rectifier element is connected to the second high-frequency terminal, and
the coil is connected to the direct current terminal.
